(19) United States
(12) Patent Application Publication
(10) Pub. No.: US 2001/0018658 A1
(43) Pub. Date: Aug. 30, 2001

(54) System for obtaining information based on communication of users

(76) Inventor: Jong Min Kim, Seoul (KR)

Correspondence Address: Timothy J. Keefer, Wildman, Harrold, Allen & Dixon, 225 West Wacker Drive, Chicago, IL, 60606, US

(21) Appl. No.: 09/793,187

(22) Filed: Feb. 26, 2001

(30) Foreign Application Priority Data
Feb. 26, 2000 (KR) 2000-9580

(51) Int. Cl. G06F 17/60; G06F 7/00; G06F 17/30; G06F 15/16

(52) U.S. Cl. 705/1; 709/217; 707/1

(57) ABSTRACT

A system for obtaining desired information, based on communication of users. The system comprises a server system for allowing a plurality of users to navigate in a virtual world, wherein the server system includes Helpee Indicator, Helper Indicator, Helpee Manager and Helper Manager for identifying user's as a helpee using a symbol, User Information Manager and Helper Estimator for calculating score of each of users in the virtual world, storing the score for each of the users, increasing the score of a user who helped other users and storing the updated score, decreasing the score of a user who interferes with other user's activities in the virtual world, increasing the score of a user who re-communicates with users who had previous helper-helpee relations.

### BACKGROUND OF THE INVENTION

1. Field of the Invention

The present invention relates to a system for searching the Internet for information. More particularly, the invention relates to a system that enables users in a three dimensional (“3D”) virtual space to share information by communicating with each other.

2. Description of the Related Art

One of the most important characteristics of the Internet is a huge and diverse amount of information, which can be both helpful and troubling to Internet users at the same time. Such enormous amount of information is useless unless a user can easily find information he/she is looking for. Hence, an efficient system for finding desired information fast and precisely is necessary for Internet users.

Many users use Internet search sites (more precisely, search engines in those sites) to search for information on an interested subject from the Internet. However, when a user tries to find a site by entering keywords in a search site, he/she ends up with a long search result including sites that actually may not related to the subject. Search sites use various schemes to help users to find sites that have the information he/she needs. For example, search results are displayed in the order of visit frequency or the relevance of the sites with the keyword the user entered. However, it still takes considerable time and effort for a user to visit all the sites in the list to finally arrive at certain sites that contain information the user desired to find.

Recently, technologies in the field of virtual reality were developed which provide so called a two dimensional or three dimensional virtual world on the Internet. The virtual world may include simulated counterpart of real world objects. Especially, users may represent themselves in the virtual world space by using their representatives commonly known as avatars. By using avatars, users in the virtual world can locate other users who are in the same virtual world. Sophisticated technologies to enhance user's convenience and usability of such virtual world are in great demand. One critical problem with virtual worlds is that it is difficult for a user to participate in activities happening there and to obtain desired information by navigating his or her avatar in the virtual world.

Accordingly, a need exists for an enhanced mechanism for enabling a user to obtain desired information by navigating through two dimensional world or three dimensional virtual world.

### SUMMARY OF THE INVENTION

It is, therefore, a primary object of the present invention to provide a system for helping users to find information fast by communicating with each other.

Specifically, another object of the present invention is to provide a means for enabling users to more quickly identify other user who needs help and to provide the user information that he/she needs.

In addition, another object of the present invention is to provide a means for encouraging users to help other users in a virtual world.

To accomplish above objects, according to the present invention, there is provided a server system for allowing a plurality of users to navigate in a virtual world, comprising:

means for representing a user by a representative in the virtual world; and

means for permitting said user to obtain information, based on communication with other users in the virtual world using said user's and other users' representatives.

In addition, the system may further comprise means for identifying said user's as a helpee using a symbol, wherein said helpee is one who requests help from other users in the virtual world; means for communicating with at least one of the users; means for calculating a score of each of users in the virtual world; means for storing the score for each of the users; means for increasing the score of a user who helped other users and storing the updated score in said storing means; means for decreasing the score of a user who interferes with other user's activities in the virtual world, and storing the updated score in said storing means; means for adjusting accessibility to a user by other users on the basis of the accumulated score for said user; means for recording information of communication with other users in the virtual world for each user; and means for increasing the score of a user who re-communicates with users who had previous helper-helpee relations.

It is desirable that said virtual world of the system may include 2D and 3D based contents, and be implemented in the site accessible by the users using 2D and 3D enabled browsers. Preferably, the identifying means displays the representative of said user identified as a helpee only to users who are in the field accessible by said helpee in the virtual world.

### BRIEF DESCRIPTIONS OF THE DRAWINGS

The above and other objects and features of the present invention will become apparent from the following description of preferred embodiments given in conjunction with the accompanying drawings, in which:

FIG. 1 is a block diagram showing an overall structure of a preferred embodiment in which the present invention is practiced;

FIG. 2 depicts a block diagram describing the components of User Information Manager 112 of FIG. 1;

FIG. 3 depicts a block diagram describing the components of Helpee Manager 124 of FIG. 1;

FIG. 4 illustrates a block diagram showing the components of Database 130 of FIG. 1; and

FIG. 5 is an example of screen display for explaining how to indicate that a user is a helpee using a chatting client/server system.

### DETAILED DESCRIPTION OF THE PRESENT INVENTION

Unlike conventional search systems, the present invention allows users to find information he/she wants by communicating with other user(s) who could be more knowledgeable about a subject than he/she is. The present invention provides a system for obtaining information from the Internet through communication among users. “Helpers” are those who are more knowledgeable about a specific topic than other users and are willing to share such knowledge with others. “Helpees” are those who need certain information but do not know where to find the information. A system according to the present invention also provides a means for encouraging the helpers to help the helpees. By doing this, a cyber community may be formed comprised of active users or participants.

In order to perform a web search, a user has to be connected to a system according to the present invention. The user is given an ID when first accessing to the system. Then the user may navigate in a virtual world (or search space) provided by a server of the inventive system to find desired information. The inventive server presents the Internet space to the user as a 3-D virtual space which includes links to various web pages, which are classified and located based on their characteristics. Such links or lists of the web sites are scattered in the virtual space so that users may have to move around in the space to search for a desired web page. For example, links to the web pages or a directory including many web pages may be represented as a door of or a sign on a building. In the search space, preferably, links to sites having similar contents tend to be located near to each other. Since the links are classified, when a user approaches a certain region in the search space, the user is likely to encounter other users who have a similar interest and are likely to give advice on the search. Examples of a 3D search space include a virtual mall where an image of electronics shop represents a gateway to an electronics company. In a virtual museum, each picture may represent a link to a web site of a painter.

It should be understood that the 3D virtual search space of the present invention may include 2D search space that is provided by, for example, Yahoo® to enable users to make use of other conventional search sites. Preferably, by using a 2D/3D browsing system disclosed in Korean Patent Application No. 10-2000-0005910 filed on Feb. 9, 2000, one can easily perform 2D/3D switching in the virtual space.

A user may become a helpee in one field and become a helper in another field. The inventive system makes it possible for a helper to quickly identify helpees in a virtual world and to communicate with the helpees to give information. A helper earns predetermined points when he/she helps a helpee. Users may enjoy various benefits based on the accumulated points in the virtual world. To encourage repetitive communication among users, a user may store a list of IDs of his/her helpers and helpees, and when the user re-communicates with one in the list, the user earns additional points. In this manner, the present invention encourages everybody in a virtual world to help each other and to share useful information with each other.

The present invention will now be described with reference to the accompanying drawings.

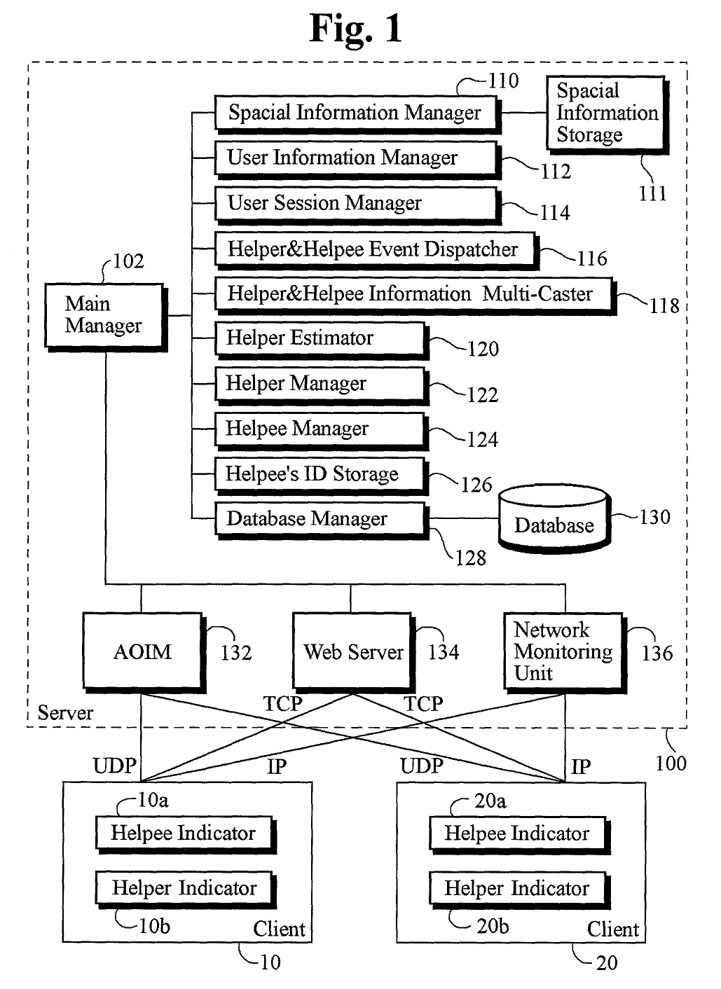

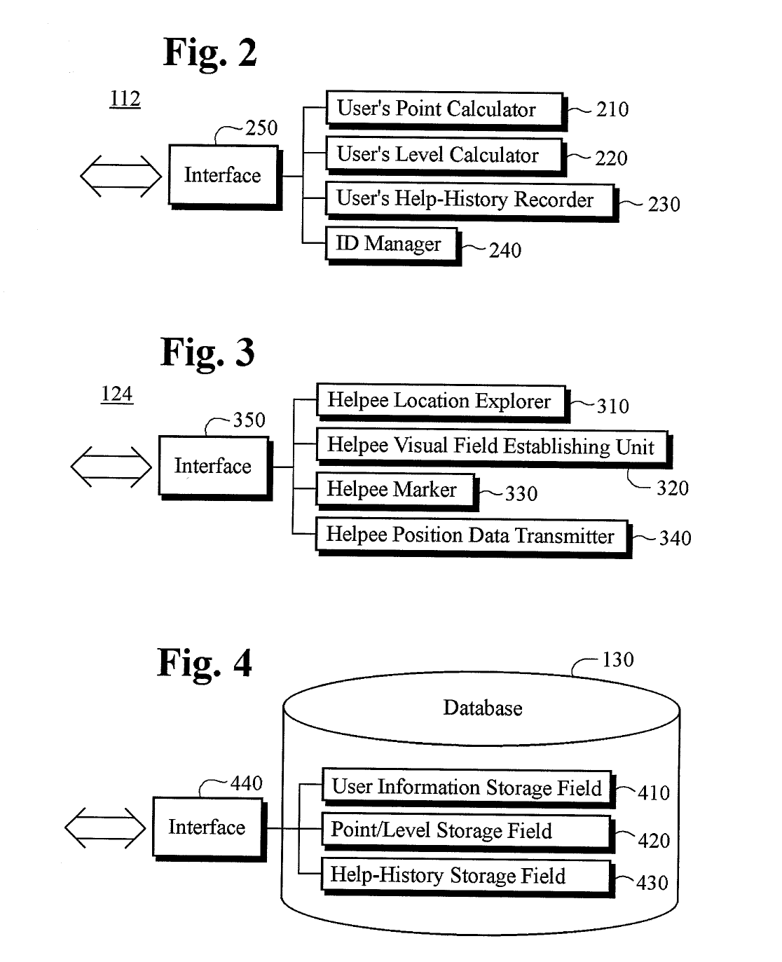

Referring to FIGS. 1 through 4, the structure and operations of a preferred embodiment of the present invention will be explained in detail. FIG. 1 illustrates the overall structure of the inventive system; FIG. 2 shows components of the User Information Manager 112 of FIG. 1; FIG. 3 shows components of Helpee Manager 124 of FIG. 1; and FIG. 4 shows components of Database 130 of FIG. 1.

A user's computer may be connected to the inventive system via a network such as the Internet. In one embodiment of the invention, the user's systems 10, 20 and the inventive system 100 may be in a client/server relationship as shown in FIG. 1.

Hereinafter, a “Server” represents an overall system depicted in FIG. 1 including subsystems that conduct various functions, e.g., a Main Manager 102, a Helpee Manager 124, a Database 130, a Web Server 134, a Network Monitoring Unit 136, etc. Further, a “Client” represents a user computer system such as a personal computer including related peripheral devices.

The Server 100 provides users with a virtual world or a virtual search space including 2D/3D information contents. In the virtual world, users are represented by, for example, avatars or emoticons. To do this, a user may determine his or her own representative and store it in the Server 100.

A browser is usually installed in each Client 10, 20 to communicate with the Server and enables the user to view the virtual world. The browser downloads data for displaying the virtual world from the Server 100. Each user's avatar may navigate in the virtual world as the user moves the avatar by using the user interface of the browser. Information regarding the movement of user's avatar in the virtual world is sent back to the Server 100. Using the information from Clients, the Server 100 updates information such as existence, appearance and movement of avatars of all users in the virtual world so that the movement of every avatar may be displayed in the browser of each of the Client.

When a user hopes to get help from others in finding desired information while navigating in the virtual world, the user sends a request for help to the Server 100 using a Helpee Indicator 10a, 20a in the Client 10, 20. For example, the Helpee Indicator 10a, 20a may be provided as a button located in a tool bar area of the browser. On user's clicking the Helpee Indicator button, a request for help is sent to the Server 100 from the Client.

In the Server 100, an AOIM (Area of Interest Manager) 132 receives the request for help from the Clients 10, 20. The AOIM, which serves as a gateway between the Server 100 and the Clients 10, 20, reports the request for help to a Main Manager 102. A Web Server 134 in FIG. 1 is a server for exclusive HTTP (hypertext transfer protocol) processing and may be associated with the AOIM 132 under the Main Manager's control. A Networking Monitoring Unit 136 uses SNMP (simple network monitoring protocol) to monitor whether a Client is accessing the Server and whether there is a malfunction or any other abnormality. The Networking Monitoring Unit 136 may also be associated with the AOIM 132 under the Main Manager's control.

In response to input from a user through the AOIM 132, the Main Manager 102 transmits the input to a Helper and Helpee Event Dispatcher 116. The Helper and Helpee Event Dispatcher 116 decodes the input to determine whether the input is data indicating that a user who transmitted the input is a helpee, that is, whether the user is asking for help from others. If the data indicates that the user is a helpee, the Dispatcher 116 sends the result of the determination to a Helpee Manager 124 via the Main Manager 102. The Helpee Manager 124 saves the ID of the helpee or the user who activated the Helpee Indicator 10a, 20a in a Helpee's ID storage 126.

A Helpee Location Explorer 310 included in the Helpee Manager 124 finds out where the user's representative or avatar is located. The located Helpee's position is communicated back to the user's Client via a Helpee Position Data Transmitter 340.

The Helpee Location Explorer 310, the Helpee Position Data Transmitter 340 and other sub-unit of the Helpee Manager 124 are shown in FIG. 3. In FIG. 3, the Helpee Manager 124 includes a Helpee Visual Field Establishing Unit 320 and a Helpee Marker 330 as well as the Helpee Location Explorer 310 and a Helpee Position Data Transmitter 340.

The Helpee Visual Field Establishing Unit 320 determines a visual field of the user's representative in the virtual world, which may be an area within a predetermined distance from the user's representative. Subsequently, under control of the Main Manager 102, the Helper and Helpee Information Multi-Caster 118 searches a Database 130 for the other users within the visual field and fetches information of the searched users from the Database 130 using a Database Manager 128.

Under control of the Main Manager 102, the Helpee Marker 330 displays a sign showing that a particular user is a helpee on Clients of the users who are within the visual field of the Helpee. To indicate a user is a helpee, a question mark or any other symbol may be displayed over the head of the user's representative. If a user within the visual field of the helpee can not see the helpee's representative because there is an obstructing object such as a wall between them, the Helpee Marker 330 may display a simple graphic icon or text message as an extra helpee-sign on the Client of the user to signify that a helpee is around though he may not be seen.

If a user within the visual field of a helpee wants to help the helpee, the user can select a Helper Indicator 10b, 20b in the Client 10, 20 and input the ID of the helpee. The Helper Indicator 10b, 20b sends an intention to be a helper, together with the helper's ID, to the Server 100.

In the Server 100, the Main Manager 102 receives the intention from the Client via the AOIM 132 and provides it to the Helper and Helpee Event Dispatcher 116. The Helper and Helpee Event Dispatcher 116 decodes the intention to determine whether the intention is data indicating that a user who transmitted the intention is a helper, that is, whether the user will help a helpee. If the data indicates that the user is a helper, the Dispatcher 116 sends the result of the determination to a Helper Manager 122 via the Main Manager 102. In other words, the Helper and Helpee Event Dispatcher 116 functions to interpret inputs transmitted from Clients. All input or request from Clients are sent to the Dispatcher 116 and are interpreted by the Dispatcher 116. The results of the interpretation or determination are transmitted to subsystems for performing processes corresponding to the results by the Dispatcher 116.

Under control of the Main Manager 102, the Helper Manager 122 saves the ID of the helper or the user who activated the Helper Indicator 10b, 20b in the Database 130. Moreover, the Main Manager 102 instructs a User Session Manager 114 to form a channel and transmit a chatting service information to the browsers of the helper and helpee, so that they can chat with each other. The User Session Manager 114 may provide a chatting service information for browsers of the helper and helpee if they want to continue to exchange information next time.

In case that the helper and/or the helpee, while communicating with each other in separated spaces, desire to move to a same space to face each other, the selection of a moving button or a link button in a toolbar provided by a browser can move them directly to a same location such as where the helpee is or where the helper is. The Helper Manager 122 and the Helpee Manager 124 have all the location information of the helper and the helpee, respectively. Hence, once a moving-request is transmitted from the Client of the helper/helpee to the Server 100, the helper/helpee can be transported directly to the predetermined space depending on said information of the Helper Manager/Helpee Manager. The Main Manager 102 permits a Spatial Information Manager 110 to transmit spatial information for the predetermined space, saved in a Spatial Information Storage 111, to the Client transmitted the moving-request. The Spatial Information Manager 110 monitors locations and movements of the all users in a virtual world and store spatial information for each user in a Spatial Information Storage 111. The spatial information is environmental information about each user's location, in other words, information for background of a user's representative in a virtual world. The Spatial Information Manager 110 updates new spatial information that resulted from a user's navigation, and stores the new spatial information in the Spatial Information Storage 111. The Spatial Information Manager 110 also provides simultaneously spatial information for all users whenever the spatial information is updated.

As mentioned above, a user activates the Helper Indicator 10b, 20b to be a helper. Then the user now as a helper communicates with a helpee, providing the helpee with desired information. Alternatively, the user may become a helper automatically if he/she initiates chatting with a helpee using a chatting window/box. In this case, the Helper Manager 122 regards the user as a helper and stores the user's ID in the Database 130.

After a user has obtained desired information from a helper, the user may no longer be a helpee. In such a case, the user inactivates the Helpee Indicator 10a, 10b to remove an indication that he/she is a helpee by restore the original representative state. The Client 10, 20 sends a restore request to the Sever 100.

In the Server 100, under of the control of the Main Manager 102, the Helpee Manager 124 deletes the ID of the user, who is no longer a helpee, from the Helpee's ID Storage. The Helpee Marker 330 removes a helpee-sign from the user's representative in the screens of other users who are within the visual field of the helpee. A Helper Estimator 120 determines how many points should be given to a helper who helped the helpee. The Helper Estimator 120 tells the User Information Manager 112 to provide the helper with the points.

Referring to FIG. 2, the User Information Manager 112 includes a User's Point Calculator 210, a User's Level Calculator 220, a User's Help-History Recorder 230 and a ID Manager 240. Under instructions from the Helper Estimator 120, the User's Point Calculator 210 calculates points for the helper using predetermined criteria, and sends the calculated points to the User's Level Calculator 220. In the point computing method, points earned by a user are determined depending on various activities in the inventive space as well as help-activities. For instance, clicking an ad banner in the space to respond to the ad is one of scoring activities. The User's Level Calculator 220 calculates the level of a helper using predetermined criteria. The points and level are sent from the User's Point Calculator 210 and the User's Level Calculator 220 to the User's Help-History Recorder 230. The User's Help-History Recorder 230 registers the scores in the Database 130.

Optionally, the present invention may provide a helpee with a means to notify the Sever 100 that a certain user abused the helpee. Similar to the case of a Helpee Indicator, a helpee may activate the means to transmit the notification signal to the Server 100. In the Sever 100, for example, the Helper Estimator 120 may permit an ID manager 20 to lock out the abusing user's ID, or may instruct the User's Point Calculator 210 and/or the User's Level Calculator 220 to reduce the abusing user's points and/or level by a predetermined amount.

Although an embodiment where a helper helps a helpee by having a chat with each other through a chatting window or chatting box was explained, there are various methods for helping a helpee. For instance, a helper's avatar is made to lead a helpee's avatar by holding hands. Or, helper's and helpee's avatars may overlap to move to their destination together in a virtual world.

As discussed above, the present invention provides a technique for providing a special relation between users in a virtual world so that a user can obtain desired information with the help of another user. Now, a technique for continuing and encouraging the relation will be explained.

Again referring to FIG. 2, the User's Help-History Recorder 230 in the User Information Manager 112 records the ID of a user who wants to be a helper or a helpee in the Database 130. In a case that a user who has been a helper or a helpee reconnects to the Server 100, the Main Manager 102 permits the User's Help-History Recorder 230 to provide the user with the IDs of users who have been a helper or helpee to the user, with reference to the Database 130. In other words, a user can re-communicate with other users who have had helper-helpee relations.

If a user re-communicates with one of other users, the User's Point Calculator 210 calculates points for the user using predetermined criteria under instruction of the User's Information Manager 112 and sends the calculated points to the User's Level Calculator 220. The User's Level Calculator 220 calculates the level of the user depending on the calculated points. The additional points and new level are sent from the User's Point Calculator 210 and the User's Level Calculator 220 to the User's Help-History Recorder 230. The User's Help-History Recorder 230 registers the points and level in the Database 130. The criteria for adjusting points and level may be the frequency and duration of repeated-communications, etc.

To encourage active involvement, the user's level or points determined as aforementioned may define the activity scope of the user in a virtual world. That is, as the level/points of a user are higher, he/her scope is expanded. For example, the visual field of a helpee whose level is high is available to more users. To do this, the Helpee visual Field Establishing Unit 320 determines the visual field of a helpee's representative in a virtual world based on levels/points stored in the User's Help-History Recorder 230.

Thus, if a user having a high level becomes a helpee, the user can have help from more of other users. As a further encouragement incentive, a user's level/points may define the moving speed of the user in the virtual world. A higher level allows a higher speed. Besides, other benefits may be provided to a user earning a large amount of points.

Referring to FIG. 4, the Database 130 in FIG. 1 is shown detail. The Database 130 may have several storage fields, including a User Information Storage Field 410, a Point/Level Storage Field 420, a Help-History Storage Field 430, and so on. The User Information Storage Field 410 is used to store data about activities for each user, and the Point/Level Storage Field 420 is used to store points and level for each user and the Help-History Storage Field 430 is used to store an ID list of the helper-helpee relation for each user.

Again referring to FIGS. 2 to 4, Interfaces 250, 350, and 440 are shown. These modules are preferred because they allow an implementation of an extensible and safe architecture in a system of the present invention. With using these modules, new components can be easily added to a system of the invention.

Now, it will be explained in more detail how to indicate that a user is a helpee and to share useful information between helpees and helpers in another embodiment of the present invention.

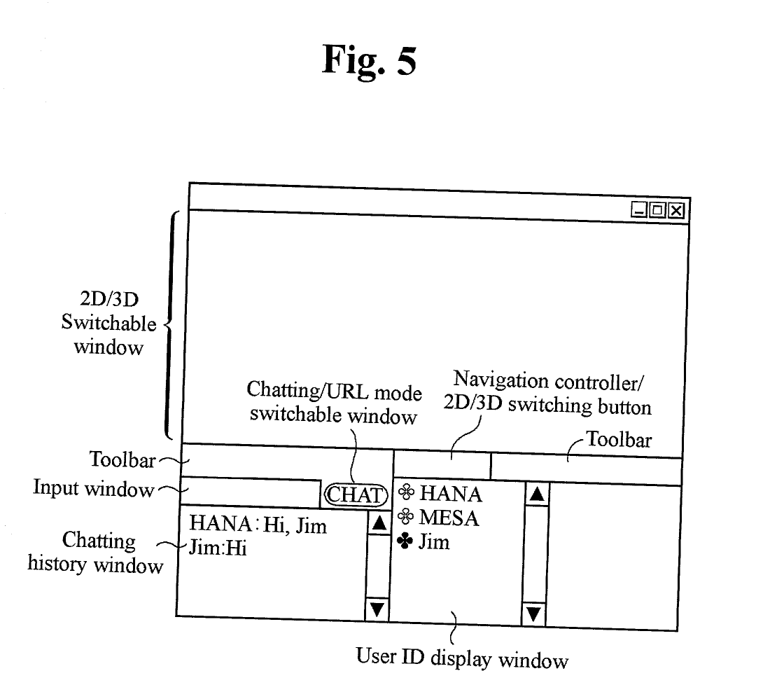

A chatting server/client system is employed as part of the inventive system for indicating a helpee and sharing useful information. The configuration of the chatting server is identical to that of a prior art chatting server. The chatting server may be connected to the Main Manager 102 of FIG. 1. A chatting client is provided as integrated with a web browser as shown in FIG. 5. It may be provided separately.

The display configuration of the chatting client comprises an input window for entering messages, a user ID display window for displaying IDs of logged-in and a chatting history window for displaying messages entered by the users. Web sites' URL as well as the chatting messages may be entered in the input window by pushing, for example, a toggle button in a toolbar area of a browser for switching between chatting and URL modes. This input window, which serves as a chatting-message/URL input switchable window, is described in a co-pending Korean Patent Application No. 10-2000-50966 filed on Aug. 31, 2000 by the same applicant of this patent application and is incorporated here by reference. The user ID display window shows the IDs of users who are connected to the inventive site. There is an icon next to each ID. In case that a user asks for help, the user's icons displayed on the screens changes. In each of the clients, a help-helpee item is enabled by clicking the icon of the user who requested help. Further, a point-input item is enabled by clicking the icon of a user who provided desired information. The chatting history window shows chatting messages exchanged between users whose clients are connected to the inventive site. Information shown in the chatting history window and the user ID display window is displayed identically on the screens of users in the inventive site.

Processes for requesting help and providing information in response to the help request are explained hereinafter.

Once a user's chatting client is connected to a chatting server, the server determines whether the user's ID is registered using the client's IP. If the IP is that of a registered user, the server displays the registered ID in the user ID display window. Otherwise, the server automatically grants a predetermined ID to non-registered user, for instance, guest1, guest2, guest3, etc. Such a method for granting an ID to a user can be adjusted in the server.

The number of users, shown in a chatting history window, may be limited or not. The number is determined such that users can help each other without inconvenience.

A user who needs help (or a helpee) selects a help-request button of a toolbar in a chatting client and enters a message requesting help in a input window. The request is transmitted to a chatting server. The server sends a signal to all the users in the same site, informing that a helpee requested help. The client that received the signal from the server displays the icon next to the helpee's ID and messages in a chatting history window in a different color, for example, red, blue, etc. In this manner, the other users can know the appearance of a helpee. In other words, the fact that a user requested help is announced through a color change of icon and messages. A user who tries to help the helpee (or a helper) clicks the icon changed in color to start a help-helpee item. The helper selects the help-helpee item to display a new window on the screen, and enters messages for giving help. The window may be an interface of conventional IMS (instant messaging services), for example. Instant messages the helper enters are transmitted to the helpee's client. Thus, the helpee can obtain desired information from the helper. They may connect directly with each other to employ peer-to-peer networking service instead of the IMS.

Processes for earning points in the above processes are explained.

Once a helper sees the color of the helpee's icon changed, he/she clicks the icon to enable a help-helpee item and sends messages, thereby earning predetermined points. To do this, the client of a helpee comprises a means for determining points to be given to a helper depending on information the helper offered. The point determination means is more useful in case that a helpee desires to give bonus points for a helper because the helper provided high quality information for the helpee or to reduce given points from the helper's points because the helper transmitted abusive words or chat Spam to the helpee.

As mentioned above, the present invention provides techniques for obtaining desired information by communicating with users who know more about a topic, representing a user, who needs certain information but does not know where to get it, with a symbol, color, etc. and encouraging users to help other users in a virtual world. Thus, the present invention provides mutual benefits to those users who visit a same site or a same zone, because they are more likely to have a common interest.

Additionally, the present invention can be applied to any application fields to obtain information: for instance, information search, information exchange, information sharing, consultation, counsel, advice and so forth.

While the present invention has been described and illustrated with respect to a preferred embodiment of the present invention, it will be apparent to those skilled in the art that variations and modifications are possible without deviating from the broad principles and teachings of the present invention which should be limited solely by the scope of the claims appended hereto.

What is claimed is:

1. A server system for allowing a plurality of users to navigate in a virtual world, comprising:
means for representing a user by a representative in the virtual world; and
means for permitting said user to obtain information, based on communication with other users in the virtual world using said user's and other users' representatives.

2. The server system according to claim 1, wherein said virtual world includes two dimensional and three dimensional contents.

3. The server system according to claim 1, further comprising:
means for identifying said user's as a helpee using a symbol, wherein said helpee is one who requests help from other users in the virtual world.

4. The server system according to claim 3, wherein said identifying means displays the representative of said user identified as a helpee only to users who are in the field accessible by said helpee in the virtual world.

5. The server system according to claim 4, further comprising:
means for communicating with at least one of the users.

6. The server system according to claim 5, further comprising:
means for calculating a score of each of users in the virtual world;
means for storing the score for each of the users; and
means for increasing the score of a user who helped other users and storing the updated score in said storing means.

7. The server system according to claim 6, further comprising:
means for decreasing the score of a user who interferes with other user's activities in the virtual world, and storing the updated score in said storing means.

8. The server system according to claim 7, further comprising:
means for adjusting accessibility to a user by other users on the basis of the accumulated score for said user.

9. The server system according to claim 8, further comprising:
means for recording information of communication with other users in the virtual world for each user; and
means for increasing the score of a user who re-communicates with users who had previous helper-helpee relations.
